(19) United States
(12) Patent Application Publication
(10) Pub. No.: US 2013/0047761 A1
(43) Pub. Date: Feb. 28, 2013

(54) ARRANGEMENT OF A GEARWHEEL

(71) Applicants: Martin Weiss, Markdorf (DE); Jurgen Rauter, Friedrichshafen (DE); Stefan Renner, Bodman-Ludwigshafen (DE); Maximilian Scheufler, Markdorf (DE)

(72) Inventors: Martin Weiss, Markdorf (DE); Jurgen Rauter, Friedrichshafen (DE); Stefan Renner, Bodman-Ludwigshafen (DE); Maximilian Scheufler, Markdorf (DE)

(73) Assignee: ZF FRIEDRICHSHAFEN AG, Friedrichshafen (DE)

(21) Appl. No.: 13/696,371

(22) PCT Filed: Apr. 4, 2011
(86) PCT No.: PCT/EP2011/055171

§ 371 Date: Nov. 6, 2012

(30) Foreign Application Priority Data
May 12, 2010 (DE) 10 2010 028 925.6

(51) Int. Cl. F16H 3/22

(52) U.S. Cl. 74/331

(57) ABSTRACT

An arrangement of a gear (2) on a main shaft (1) of a transmission having at least two countershafts (3, 4). The gear (2) is designed as a summation gear or gear wheel, and the gear (2) is connected to the countershafts, in a rotationally drivable manner, and is disposed radially movable between the two countershafts (3, 4). The arrangement has a damping bush (5) which is disposed between the gear (2) and the main shaft (1). The damping bush (5) comprises a hard outer sliding ring (6) and an elastomeric part (7) that is in fixed connection to an inwardly facing surface of the outer sliding ring (6).

This application is a National Stage completion of PCT/EP2011/055171 filed Apr. 4, 2011, which claims priority from German patent application serial no. 10 2010 028 925.6 filed May 12, 2010.

### FIELD OF THE INVENTION

The invention relates to an arrangement of a gear on a main shaft of a transmission having at least two countershafts, and a damping bush, for use in the named arrangement.

### BACKGROUND OF THE INVENTION

It is known with transmissions having a main shaft and two countershafts that a load distribution occurs between the power flows via the two countershafts. For this purpose, the gears disposed on the main shaft, which are also called summation gears and engage in gearing of the countershafts, are disposed movable radially with respect to the main shaft, and are guided radially or centered by the gearing of the countershafts. Axial guidance of the summation gears, which in a shift transmission are designed as gear wheels, occurs by means of thrust washers disposed laterally on the main shaft for example.

A disadvantage with such an arrangement of summation gears on the main shaft is that undesired noises, so-called rattling noises, arise as a consequence of the axial and radial movability and external vibrational excitation of the gears.

For reducing these rattling noises, the document DE 102004057126 A1 proposes an arrangement of a summation gear on a main shaft and a transmission having a main shaft and two countershafts, with which a spring element in the shape of a disk spring is disposed between an axial thrust washer and the gear in order to reduce the axial play of the main shaft gear, and thus to minimize the undesired rattling noises.

The document DE 10 2007 015 998 A1 describes an arrangement of a gear on a main shaft of a transmission having at least two countershafts, with which the radial movability of the summation gears between the countershafts is restricted by an elastic element, which is disposed between the gear and the main shaft and/or between the gear and the countershaft. In this manner, the rattling noises are further reduced in such a transmission. According to the document DE 10 2007 015 998 A1, the elastic element can be designed, for example, as a spring ring or as an elastomer. In addition, a separate sliding ring is described that can be disposed between the elastic element and the countershaft.

### SUMMARY OF THE INVENTION

Based on the subject matter of the document DE 10 2007 015 998 A1, the problem addressed by the present invention is to specify an arrangement of a gear on the main shaft of the transmission having at least two countershafts with load distribution, which comprises an elastic element. The arrangement should be easy to install and guarantee reliable long-term reduction of rattling noises.

An arrangement of a gear on a main shaft of the transmission having at least two countershafts is claimed wherein the gear is designed as a summation gear or gear wheel. The gear is disposed radially movable between two countershafts, and is in rotationally drivable connection to the countershafts, either directly or via reverse gears. An elastomeric part is disposed between the gear and the main shaft.

According to the invention, the arrangement comprises a damping bush, which is disposed between the gear and the main shaft and is composed of a hard outer sliding ring and an elastomeric part that is in fixed connection to the outer sliding ring, and is disposed within the outer sliding ring.

As a result of the elastomeric part and the outer sliding ring being pre-assembled as one part in the form of a damping bush, they can be installed together as one part in the arrangement, or respectively the transmission. This simplifies the handling of parts and the assembly of the transmission, and minimizes the risk of assembly errors.

The outer sliding ring according to the invention is composed of a hard material, for example metal or hard plastic. A hard material is understood here to be any material that is suitable to provide the outer sliding ring sufficient stability and surface hardness during the assembly and in operation, such that the function thereof as a part of the damping bush can be fulfilled.

The elastomeric part is preferably designed in the shape of a ring so that, together with the outer sliding ring, it forms a ring-shaped damping bush, the outside thereof having a hard, sliding surface and the inside thereof having a flexible and elastic surface.

To permit the initially described load distribution, and in the process to guide the gear in a controlled manner, the gear in the proposed arrangement is guided elastically via the outer sliding ring of the damping bush acting as a slide bearing. The radial movements of the gear on the main shaft are uniformly damped in all radial directions by the ring-shaped elastomeric part such that rattling noises are substantially reduced in this arrangement.

The fixed connection between the hard outer sliding ring and the elastomeric part is preferably attained in that the elastomeric part is vulcanized or bonded in the outer sliding ring.

The flexibility of the elastomeric part allows a further preferred embodiment of the invention, according to which the outer diameter of the main shaft is greater, at least in the axial region of the installed damping bush, than the inner diameter of the ring-shaped elastomeric part in the un-installed state. During installation of the damping bush on the main shaft the inner diameter of the elastomeric part adapts to the outer diameter of the main shaft, whereby a pretensioning arises in the damping bush. In this manner, the damping bush can be disposed on the main shaft with a defined pretension, whereby undesired rattling noises can be further reduced. The amount of pretensioning can be set optimally by changing the outer diameter of the main shaft in the region of the damping bush and/or by changing the inner diameter of the elastomeric part.

A further possibility to change the damping characteristic of the damping bush with respect to a minimal development of transmission noise consists in selecting the material of the elastomeric part. For this purpose a plurality of elastomers with different hardnesses are available on the market that can be purposefully selected for optimizing the noise damping.

Manufacturing inaccuracies of the components can also be compensated for using the described arrangement of the damping bush on the main shaft with pretensioning.

According to a further preferred embodiment of the invention, the elastomeric part has an inner gearing that engages in an outer gearing of the main shaft during installation of the damping bush on the main shaft. Thus, the damping bush can be installed using minimal construction space.

It is particularly preferable to dispose the damping bush in the assembled state in a circumferential groove on the main shaft, wherein the circumferential groove interrupts the outer gearing of the main shaft in the axial direction, and wherein the inner gearing of the elastomeric part is rotated in the groove with respect to the outer gearing of the main shaft such that the elastomeric part, and with it the damping bush, is fixed in the axial direction with respect to the main shaft. In the installed, rotated state, the face surfaces of the teeth of the inner gearing of the elastomeric part meet at the face surfaces of the teeth of the outer gearing.

In order to secure the rotation of the damping bush on the main shaft, and thereby to fix the damping bush in the groove, the arrangement preferably comprises a pin disposed coaxially to the main shaft that engages in a tooth gap of the inner gearing of the elastomeric part, and thus holds the damping bush securely on the main shaft secured against rotation. This guarantees that the damping bush in the disengaged state of the associated transmission step does not rotate along with the gear rotating with respect to the main shaft, and that this way, an undesired relative movement between the main shaft and the elastomeric part can occur, by means of which the elastomeric part could be damaged. In the case of a disengaged transmission ratio step, relative movement during operation should occur between the outer sliding ring and the gear.

After installation of all gears, shift elements, thrust washers and damping bushes disposed on the main shaft, the pin is slid along the outer periphery of the main shaft, and along with the damping bush can also secure other components disposed on the main shaft against rotating with respect to the main shaft.

In order to attain the pretensioning of the damping bush described above, in the case of the latter embodiment, the main shaft diameter in the region of the peripheral groove is designed greater than the inner diameter of the main shaft in the region of the outer gearing, so that in the region of the groove a socket arises on which the damping bush is disposed with pretensioning.

Finally, the invention comprises also a damping bush for use in the described arrangement, wherein the damping bush consists of a hard outer sliding ring and an elastomeric part securely connected to the outer sliding ring. The outer sliding ring of the damping bush is preferably composed of metal. The elastomeric part is preferably designed ring-shaped within the outer sliding ring and the inner periphery thereof has an inner gearing.

The invention is described in more detail based on an example embodiment that is represented in the following described figures.

### BRIEF DESCRIPTION OF THE DRAWINGS

The figures show:

FIG. 1 a sectional representation with a section from an arrangement according to the invention for the reverse gear step,

FIG. 2 a sectional representation of a damping bush, and

FIG. 3 a perspective view of a damping bush.

### DETAILED DESCRIPTION OF THE PREFERRED EMBODIMENTS

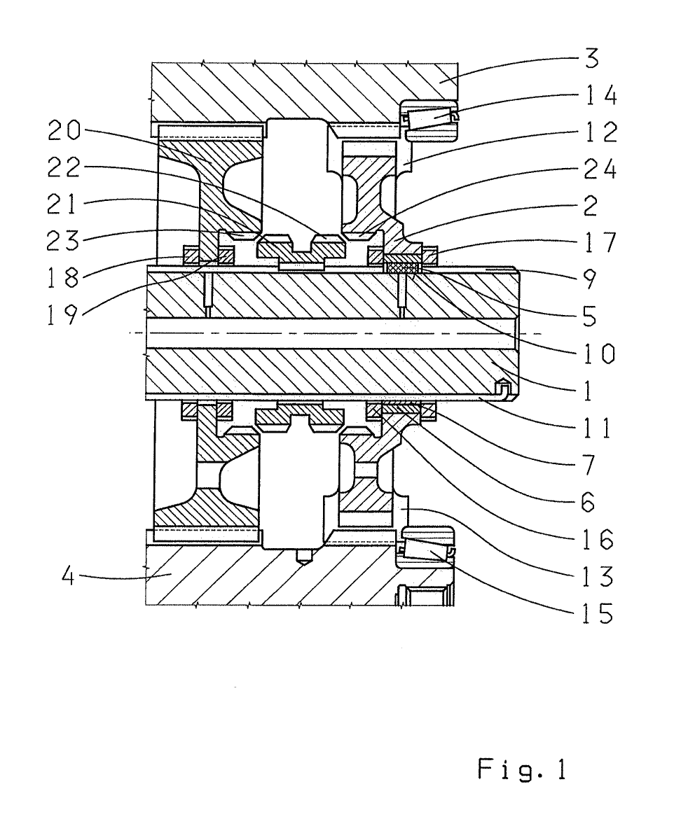

The arrangement according to the invention according to FIG. 1, comprises the main shaft 1, two countershafts 3 and 4 disposed in parallel to the main shaft 1, as well as the gear 2, which is disposed as a summation gear, rotatable on the main shaft 1 by means of the damping bush 5. The gear 2 is connected rotationally drivable to the gearing of the countershafts 3 and 4 via the reverse gears 12 and 13.

The countershafts 3 and 4 can be rotated by means of roller bearings 14 and 15, however, are mounted radially fixed in the transmission housing, against which the main shaft 1 floats, that is, is mounted with play in the radial direction in the components of the transmission, not shown.

The gear 2 is guided on the main shaft 1 in the axial direction by means of two thrust washers 16 and 17. The gear 2 is mounted on the main shaft 1 in the radial direction by means of the damping bush 5. The damping bush 5 is composed of a hard outer sliding ring 6 and a flexible elastomeric part 7 secured in the outer sliding ring 6. The outer sliding ring 6 is composed for example of metal having good sliding properties, and the elastomeric part 7 is vulcanized in the outer sliding ring 6.

The elastomeric part 7 is designed having a ring shape and on the inner diameter thereof has an inner gearing 8 that can be clearly seen particularly in FIG. 3. With the assembly of the damping bush 5, the inner gearing 8 engages in an outer gearing 9 applied on the main shaft 1, whereas the damping bush 5 is slid with the inner gearing 8 over the outer gearing 9 onto the main shaft 1. In the region in which the gear 2 and the damping bush 5 are supported during operation on the main shaft 1, the outer gearing 9 of the main shaft 1 has a discontinuity in the shape of a circumferential groove 10. The damping bush 5 with the inner gearing 8 thereof is rotated in this groove 10 by the width of a tooth with respect to the main shaft 1 and the outer gearing 9 thereof, such that the elastomeric part 7 and with it, the damping bush 5, is secured in the axial direction with respect to the main shaft 1.

The rotated position of the damping bush 5 is secured with respect to the main shaft 1 by a pin 11. For this purpose, after the installation of the components disposed on the main shaft 1, the pin 11 is slid in an axial direction into one of the tooth gaps of the inner gearing 8 and the outer gearing 9, and is fixed. The pin 11 holds the damping bush 5, and also the thrust washers 16 and 17 for example, rotationally fixed on the main shaft 1.

In addition to the gear 2 for the reverse gear, the gear 20 for the first forward gear is disposed with radial play on the main shaft 1. The teeth of the gear 20 engage in the gearing of the two countershafts 3 and 4, such that the gear 20 is guided radially, or respectively centered, in the gearings of the countershafts 3 and 4. The gear 20, as well as the gear 2, is guided in the axial direction on the main shaft 1 by two thrust washers 18 and 19.

A sliding sleeve 21, with which the gear is shifted in a conventional manner, is disposed on the main shaft 1 so that it is axially slidable between the gear 2 and the gear 20. The sliding sleeve 21 has an inner gearing that engages in the outer gearing 9 of the main shaft 1 whereby the sliding sleeve 21 is connected rotationally fixed to the main shaft 1. The sliding sleeve 21 additionally has an outer gearing 22 which, by axially sliding the sliding sleeve 21, can be brought into engagement with an inner gearing 23 or 24 of the gears 2 or 20, so that the corresponding gear is connected rotationally fixed to the main shaft 1 and the corresponding transmission ratio step is engaged in the transmission.

The arrangement according to the invention in this example embodiment relates only to the reverse gear step. There, the damping bush 5, due to the flexibility of the elastomeric part 7, ensures that the gear 2 allows radial movement of the gear 2 with respect to the main shaft 1 for the purpose of load distribution, at the same time however, rattling noises are avoided because the gear 2 is not freely movable within the radial play even in the case of a disengaged reverse gear. The avoidance of rattling noises applies particularly in the case of a disengaged reverse gear, which during operation of the transmission represents the greatest percentage of the time.

The arrangement according to the invention, represented in this example embodiment only for the reverse gear steps, is also suitable for the forward gears steps. In an arrangement according to the invention for a forwards gear step, the gear 2 engages directly in the gearing of the countershafts 3 and 4, while the gear 2 in the represented arrangement for the reverse gear step is connected rotationally drivable to the countershafts 3 and 4 via the reverse gears 12 and 13 that reverse the direction of rotation.

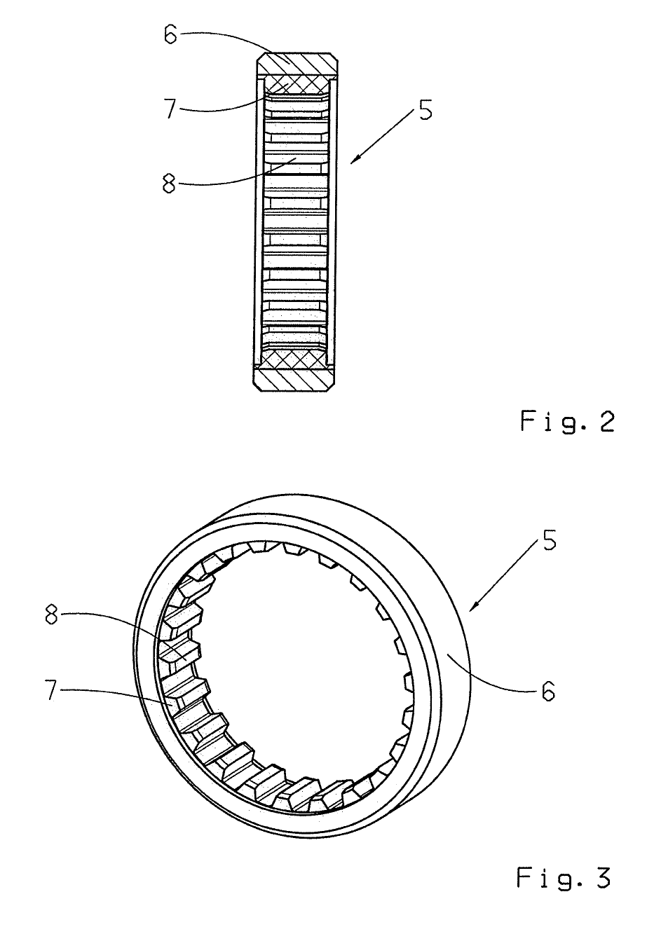

The damping bush 5, with the hard outer ring 6 and the flexible elastomeric part 7, is shown separately in FIG. 2 and FIG. 3. The elastomeric part 7 has the inner gearing 8 described above.

### REFERENCE CHARACTERS

1 main shaft

2 gear

3 countershaft

4 countershaft

5 damping bush

6 outer sliding ring

7 elastomeric part

8 inner gearing

9 outer gearing

10 groove

11 pin

12 reverse gear

13 reverse gear

14 roller bearing

15 roller bearing

16 thrust washer

17 thrust washer

18 thrust washer

19 thrust washer

20 gear

21 sliding sleeve

22 outer gearing

23 inner gearing

24 inner gearing

1-13. (canceled)

14. An arrangement of a gear (2) on a main shaft (1) of a transmission having at least first and second countershafts (3, 4), the gear (2) being designed as either a summation gear or a gear wheel,
the gear (2) being disposed connected rotationally drivable to the first and the second countershafts and radially movable between the first and the second countershafts (3, 4), and
an elastomeric part (7) being disposed between the gear (2) and the main shaft (1),
wherein damping bush (5), which is disposed between the gear (2) and the main shaft (1), and comprises a hard radially outer sliding ring (6) and a radially inner elastomeric part (7) in fixed connection to the outer sliding ring (6).

15. The arrangement according to claim 14, wherein the elastomeric part (7) is vulcanized to the outer sliding ring (6).

16. The arrangement according to claim 14, wherein the elastomeric part (7) is bonded to the outer sliding ring (6).

17. The arrangement according to claim 14, wherein the elastomeric part (7) is ring-shaped.

18. The arrangement according to claim 14, wherein a diameter of the main shaft (1), at least in the axial region of the installed damping bush, is greater than an inner diameter of the elastomeric part (7) in an un-installed state, such that the damping bush (5), following installation, is disposed on the main shaft (1) with pretensioning.

19. The arrangement according to claim 14, wherein the elastomeric part (7) has an inner gearing (8), which, at least during installation of the damping bush (5) onto the main shaft (1), engages with an outer gearing (9) of the main shaft (1).

20. The arrangement according to claim 19, wherein the damping bush (5), in an installed state, is disposed in a peripheral groove (10) on the main shaft (1), and the inner gearing (8) of the elastomeric part (7) is rotated with respect to the outer gearing (9) of the main shaft (1) such that the elastomeric part (7) and the damping bush (5) are fixed in an axial direction with respect to the main shaft (1).

21. The arrangement according to claim 20, wherein the arrangement comprises a pin (11) disposed coaxially to the main shaft (1) which, in an installed state, connects the damping bush (5) rotationally fixed to the main shaft (1).

22. The arrangement according to claim 14, wherein the outer sliding ring (6) comprises metal.

23. The arrangement according to claim 14, wherein the outer sliding ring (6) comprises plastic.

24. A damping bush (5) for use with an arrangement of a gear (2) on a main shaft (1) of a transmission having first and second countershafts (3, 4);
the damping bush (5) comprising a hard radially outer sliding ring (6) and a radially inner elastomeric part (7) fixedly connected to the outer sliding ring (6); and
the damping bush (5) being disposable between the gear (2) and the main shaft (1) for reducing rattling noise of the gear during use.

25. The damping bush (5) according to claim 24, wherein the outer sliding ring (6) comprises metal.

26. The damping bush (5) according to claim 24, wherein the elastomeric part (7) is ring-shaped and accommodated within the outer sliding ring (6) and the elastomeric part (7) has an inner gearing (8) on the inner periphery thereof.

27. An arrangement of a gear on a main shaft of a transmission having at least first and second countershafts,
the gear being either a summation gear or a gear wheel,
the gear being drivable coupled to the first and the second countershafts and radially movable between the first and the second countershafts, and
a damping bush comprising a radially outer hard sliding ring and a radially inner elastomeric part for reducing rattling noise, and the elastomeric part being continuously connected to a radially inwardly facing surface of the sliding ring so as to prevent relative rotation therebetween, and the elastomeric part being directly supported by the main shaft while the gear being directly supported by the sliding ring.
